(19) United States
(12) Patent Application Publication
(10) Pub. No.: US 2022/0392327 A1
(43) Pub. Date: Dec. 8, 2022

(54) DEVICE AND METHOD FOR MONITORING A SWITCH CABINET DOOR

(71) Applicant: TURCK Holding GmbH, Halver (DE)

(72) Inventors: Franz Grabowski, Xanten (DE); Adalbert Gabrysch, Dorsten (DE); Marcel Mertens, Duisburg (DE)

(21) Appl. No.: 17/831,453

(22) Filed: Jun. 3, 2022

(30) Foreign Application Priority Data
Jun. 7, 2021 (DE) 10 2021 114 531.7

(51) Int. Cl. G08B 21/18; G01S 15/62

(52) U.S. Cl. CPC G08B 21/18; G01S 15/62

(57) ABSTRACT

An I/O system component for a switch and control cabinet for components and/or functional units of an I/O network, including: a housing with a front, a top, a bottom, at least one side face, and a sensor window; at least one ultrasonic sensor for detecting at least one physical quantity, the at least one ultrasonic sensor being arranged behind the sensor window; and at least one printed circuit board, the at least one ultrasonic sensor being connected to the printed circuit board so as to carry data.

### CROSS-REFERENCE TO PRIOR APPLICATIONS

This application claims benefit to German Patent Application No. DE 10 2021 114 531.7, filed on Jun. 7, 2021, which is hereby incorporated by reference herein.

### FIELD

The present invention relates to an I/O system component, a switch and control cabinet, and a method for monitoring a switch cabinet door.

### BACKGROUND

Sensor-based systems for monitoring a switch cabinet door in order to prevent an undesired ingress of dust, shavings, liquids etc., which could compromise functions and the compliance with explosion prevention conditions, are known in the state of the art.

On this, an electronic lock and locking system is known from DE 11 2016 0044 841 T5. This comprises a locking element, which is electronically activatable, as well as a wireless communications module and an electronic control module, which operates in various operating modes. Status data of the lock are autonomously sent to a central control unit and evaluated there, with the result that open states can be detected and evaluated.

Furthermore, DE 10 2015 105 212 A1 discloses a sensor device which is capable of recognizing a change in several environmental parameters, such as air humidity and air temperature, in the switch and control cabinet over time and/or the position of the switch and control cabinet door. Here, the relevant sensor signals are evaluated and transmitted via a communications channel to a control centre or displayed via one or more coloured LEDs at the location of the switch and control cabinet.

Although in principle these solutions guarantee the monitoring of a cabinet door and the signalling, they are complicated in design terms since additional power supplies and input channels are required, with the result that these solutions are also economically disadvantageous.

### SUMMARY

In an embodiment, the present invention provides an I/O system component for a switch and control cabinet for components and/or functional units of an I/O network, comprising: a housing with a front, a top, a bottom, at least one side face, and a sensor window; at least one ultrasonic sensor for detecting at least one physical quantity, the at least one ultrasonic sensor being arranged behind the sensor window; and at least one printed circuit board, the at least one ultrasonic sensor being connected to the printed circuit board so as to carry data.

In an embodiment, the present invention also provides a switch and control cabinet for components and/or functional units of an I/O system network, comprising: a switch and control cabinet housing with a switch cabinet door tiltably and/or pivotably mounted on at least one pivot axis, at least one I/O system component, as well as current-carrying and/or fastening means for the at least one I/O system component, wherein the at least one I/O system component comprises an ultrasonic sensor configured to determine the distance and/or the change in distance of an inner surface of the switch cabinet door from the at least one I/O system component and/or a subcomponent of the I/O system component.

In an embodiment, the present invention also provides a method for monitoring a switch cabinet door of a switch and control cabinet for components and/or functional units of an I/O network, comprising: determining the actual position of the switch cabinet door compared to a target position of the switch cabinet door using a sensor, the actual position and the target position determined as a distance and/or change in distance of an inner surface of the switch cabinet door from an I/O system component and/or a subcomponent of the I/O system component located inside the switch and control cabinet; and saving data about the distances and/or changes in distance at least temporarily in a connected storage medium and/or triggering a warning or notification signal.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a schematic side and sectional view of a switch and control cabinet of an I/O system component, as a partially open gateway module,

FIG. 2 the switch and control cabinet according to FIG. 1 with open switch cabinet door in perspective view,

FIG. 3 an embodiment of the switch and control cabinet analogous to FIG. 1 with an alternative arrangement of the ultrasonic sensor in the gateway module,

FIG. 4 a detail view of the front of the gateway module, next to electronic components or further I/O system components,

FIG. 5 a schematic, horizontal sectional representation of the gateway module,

FIG. 6 a schematic structure of the ultrasonic sensor with associated sensor printed circuit board as a circuit diagram, and

FIGS. 7a, b, c the ultrasonic sensor in three views.

### DETAILED DESCRIPTION

Embodiments of the present invention demonstrate a solution which has a simple design and is economically advantageous, in order to make it possible in design terms to monitor the closure of a switch and control cabinet and to monitor it reliably.

In an embodiment, advantages of the present invention are achieved by an I/O system component, which is to be provided in particular for a switch and control cabinet for components and/or functional units of an I/O network. It comprises a housing with a front, a top, a bottom and, as a rule, two side faces, wherein these orientations are meant looking at the usual installed position in a switch and control cabinet, without limiting the invention in the process. In its usual installed position, the front of the housing stands with its longitudinal extent vertical and parallel to a housing door or closing door of an associated switch and control cabinet, in or to which the I/O system component is introduced or attached. Furthermore, the I/O system component comprises at least one printed circuit board with usual electronic components and functional elements and at least one sensor for detecting at least one physical quantity.

The crux here is that the housing of the I/O system component has a sensor window and the at least one sensor is an ultrasonic sensor, optionally with an associated sensor printed circuit board, wherein the ultrasonic sensor and the optional associated sensor printed circuit board are arranged inside the housing of the I/O system component, wherein here the ultrasonic sensor is arranged behind the sensor window. By “behind” the sensor window is meant any immediate vicinity, also receiving the ultrasonic sensor in the sensor window as a supporting and retaining frame for the ultrasonic sensor. The ultrasonic sensor and/or the associated sensor printed circuit board is connected to the printed circuit board (host board) of the I/O system component at least so as to carry data. Ideally, the supply is also effected via the printed circuit board.

By an I/O system component is intended to be meant quite generally an electronic, I/O-compatible component or assembly, which is integrated in particular in an I/O system network and is usually housed in a switch and/or control cabinet for the network or a network segment. In particular, the I/O system component can be an I/O module, a gateway module, a unit for supplying power or another electrical/electronic component.

Furthermore, switch and control cabinet, which can also be read as switch and/or control cabinet, is intended to have a non-limitative meaning, and means any housing with a non-destructive, releasable opening possibility, in particular a door- or flap-type opening element, in which electronic, data-carrying and/or data-processing components are housed, in particular on a common supporting and/or supply structure.

In order to produce the conductive connection to and/or compatibility of the sensor printed circuit board with the printed circuit board of the I/O system component and the supply voltage thereof, it can contain further necessary semiconductors and electronic components, such as for example linear voltage regulators, IO level converters, capacitors and resistors.

In the case of the position of the ultrasonic sensor, the important thing is that the beam angle of the ultrasound is oriented such that it can strike a surface facing the front of the housing perpendicularly or as perpendicularly as possible in its TARGET position, with the result that the distance and/or changes in distance from this facing surface, in particular a facing inner surface of a door or a cover, can be determined by means of the ultrasonic sensor.

Here, the measurement principle is such that the ultrasonic sensor integrated in the I/O system component in the switch and control cabinet measures the distance between the sensor or the I/O system component and the inner surface of the switch and control cabinet door or the inspection window in the switch and control cabinet door. The sensor itself ideally operates in a pulse-echo mode. Here, a single ultrasonic sensor emits and receives its own reflected ultrasound. The distance from the reflecting object or surface is measured through the measurement of the sonic wave travel time (round trip time), also called time-of-flight (ToF). Using a special ASIC unit, the distance from the object (door or pane) is calculated from the round trip time and, if necessary, saved at least periodically. The measured values or data derived herefrom can be retrieved, for example cyclically, by a microcontroller of the I/O system component via an Inter-Integrated Circuit (I²C or TWI interface).

In the case of an improved embodiment of the I/O system component, at least one temperature sensor and/or humidity sensor is arranged inside the I/O system component in addition to the ultrasonic sensor. As a result, the individual items of physical measured data can be verified in a reciprocal manner and, if necessary, limit values can be combined and dynamically adapted, because, when the switch and control cabinet door is open, the individual physical quantities generally undergo a change at different rates, depending on the width of the opening of the cabinet door and the temporary states of the surrounding atmosphere.

In the case of an embodiment of the I/O system component that is particularly advantageous in terms of design and economically, the sensor window is arranged in the front surface of the housing, wherein the ultrasonic sensor is arranged behind the sensor window. No ultrasound-directing reflective element is arranged on the front of and/or adjacent to the sensor window, but rather the ultrasound can strike a facing surface in a straight line without diversion, be reflected there and subsequently be received again by the ultrasonic sensor in the same sensor window.

An alternative embodiment provides for arranging the sensor window not on the front, but rather in the top, the bottom and/or one of the side faces, and for providing an ultrasound-directing reflective element adjacent to the sensor window. This is oriented and tilted in such a way that the angle of the ultrasound emitted by the ultrasonic emitter is deflected, in particular is deflected in its direction by 90°, and as a result can subsequently be directed perpendicularly or substantially perpendicularly onto a surface facing the front.

The ultrasonic sensor is ideally a miniature ultrasonic sensor with external dimensions (W×L×H) of less than 5×5×3 mm, ideally of less than 4×4×1.5 mm. This miniature ultrasonic sensor operates in the low-voltage region of typically 1.8 VDC.

The above-mentioned ultrasonic sensor is here suitable for detecting distances of from 4 cm to 120 cm with a very high accuracy.

The ultrasonic sensor with the associated sensor printed circuit board is constructed as a module, comprising an ultrasonic converter (ultrasonic transducer), an analogue-to-digital converter (ADC), a digital signal processor (DSP) and a microcontroller (μcontroller). The ultrasonic sensor ideally operates according to the above-mentioned ToF method (time-of-flight method), in which the travel time (round trip time) of the sound is determined. The linking and connection to a superordinate host microcontroller are effected in a known manner via an I²C or TWI interface, which can likewise be arranged on the sensor printed circuit board.

The invention also comprises a switch and control cabinet, in particular for components and/or functional units of an I/O network. Here, the switch and control cabinet comprises a switch and control cabinet housing with a switch cabinet door, which is tiltably and/or pivotably mounted on at least one pivot axis, wherein at least one I/O system component, as well as current-carrying and/or fastening means for the I/O system component and/or optionally furthermore provided electronic components, are arranged inside the switch and control cabinet. The pivot axis of the switch cabinet door can be part of a door hinge of any design which is suitable for guiding the switch cabinet door from a closed or locked position (TARGET or starting position) into at least one temporary and/or sometimes open position (ACTUAL position) and holding it.

The crux here is that the I/O system component comprises an ultrasonic sensor or is itself formed as a smart ultrasonic sensor by means of which the distance and/or the change in distance of the inner surface of the switch cabinet door of the switch and control cabinet housing from the I/O system component and/or a (sub)component of the I/O system component can be detected. This is in particular in order to monitor the distance of the I/O system component and/or a (sub)component thereof from the inner surface of the switch cabinet door in the closed or locked position as the TARGET position and to report deviations of the distance and the length of time.

In an exceptional case, a single I/O system component as a spatially separate component or separate assembly represents the entire I/O system, with the result that the switch and control cabinet encloses only this one component or assembly. This exceptional case can in particular occur when the single I/O system component does not satisfy the requirements for certain protection classes at the place of use and thus must be additionally encapsulated. As a rule, further electrical and/or electronic components will be housed in a switch and control cabinet in addition to the I/O system component according to the invention.

Advantageously, the switch and control cabinet is equipped here with an I/O system component, as has been described above in different embodiments. In one embodiment, the switch and control cabinet is equipped with a switch cabinet door which has at least one inspection glass on at least one partial surface of the switch cabinet door, wherein in this case by the inner surface of an inspection glass is also meant the inner surface of the switch cabinet door. In the switch and control cabinet, the ultrasonic sensor can advantageously be arranged in such a way that it, the sensor window and/or the reflective element is arranged at the height of or facing the inspection glass in the switch cabinet door.

In the method according to the invention for monitoring a switch cabinet door of a switch and control cabinet, in particular of a switch and control cabinet for components and/or functional units of an electronic network, in particular an I/O network, the ACTUAL position of the switch cabinet door compared to a TARGET position of the switch cabinet door is determined in an analogous manner to the above embodiments, by means of a sensor, as a distance and/or change in distance of the inner surface of the switch cabinet door and/or its inspection glass from an I/O system component and/or a subcomponent of the I/O system component located inside the switch and control cabinet.

Here, the measured values and signals of the sensor and/or the data, in particular digital data, derived herefrom about the distances, changes in distance and/or the duration thereof, are saved at least temporarily in a connected storage medium and/or a warning or notification signal is triggered. This also comprises the transfer of analogous measured values or digital data converted herefrom to a downstream control or processor unit (host processor), which subsequently emits a warning or control signal.

Furthermore, the warning or notification signal can also consist of an optical display, in particular of an LED display at an inner surface of a component in the switch and control cabinet, in particular on the housing of the I/O system component itself.

In the case of the variant of the method, the warning or notification signal is triggered after a defined deviation time of the ACTUAL position from the TARGET position and/or after a total number of deviation times of the ACTUAL position from the TARGET position (closed and locked position). Advantageously, the distance and/or the change in distance is detected by means of an ultrasonic sensor, which in the case of a further improved variant is arranged inside the I/O system component as an integral part of the I/O system component.

In summary, through the complete or partial opening of the switch cabinet door, the distance of the inner surface of the inspection glass or of the door from the ultrasonic sensor is increased and in parallel the angle of an ultrasonic wave reflected by the inner surface changes. As a result, the travel time of the reflected signal (received signal) is increased and/or weakened, which is recognized as an increase in distance. A special calibration of the ultrasonic sensor is not necessary here.

The threshold values for a closed state (TARGET position) of a switch cabinet door and one or more open states (ACTUAL position), can be learned via the microcontroller of the I/O system components and stored in an associated memory. If necessary, the result of the detection of an ACTUAL position, in particular as an open switch and control cabinet door, is sent directly or indirectly to a control system by the I/O system component.

The ultrasonic sensor or the ultrasonic module carries out the distance measurements at a configurable sampling rate and saves the measured data/values or data derived herefrom in the data store on the sensor printed circuit board. The microcontroller of the I/O system component (host processor) reads these measured data or the data derived herefrom and, if necessary, transfers or further processes these data.

Advantageously, the I/O system component and/or the switch and control cabinet is formed according to one of the above-mentioned embodiments. Further details and advantages of the invention are now to be explained in more detail with reference to an embodiment example represented in the drawings.

In the following, reference numbers always have the same meaning and are not always mentioned or explained again in the text, despite being represented in the figures, if this has already been done in relation to another figure.

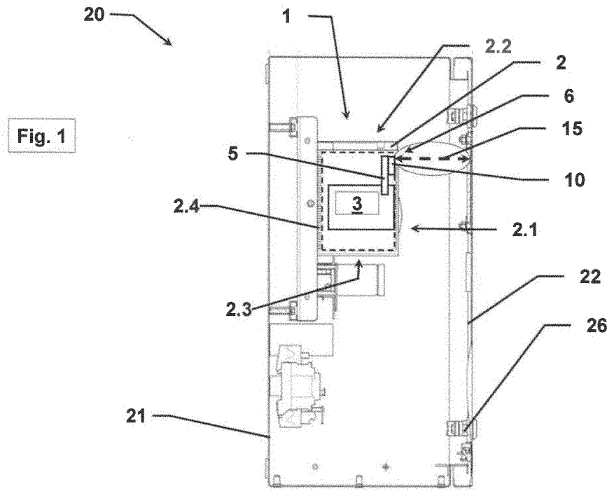

FIG. 1 shows the switch and control cabinet 20, in which a gateway module 1 is represented, from the side, by way of example as an I/O system component. The switch and control cabinet has a switch and control cabinet housing 21 substantially on its rear side, wherein the front is formed by the switch cabinet door 22, which can be closed by means of the locking device 26 provided multiple times and is represented closed, which corresponds to the TARGET position of the switch cabinet door 22.

The gateway module 1 has a housing 2, with a front 2.1, which faces the switch cabinet door 22, as well as with a top 2.2, a bottom 2.3 and two side faces 2.4. In the front 2.1, a sensor window 6 is provided as an opening, behind which, inside the gateway module 1, an ultrasonic sensor 10 is arranged, which in turn is fastened to a sensor printed circuit board 5. The sensor printed circuit board 5 is connected to the central printed circuit board 3 (host board) of the gateway module 1 so as to carry data and/or as a voltage source.

With the double arrow at the height of the sensor window 6, the sound directions 15 of the emitted and reflected ultrasound are sketched as a dashed double arrow.

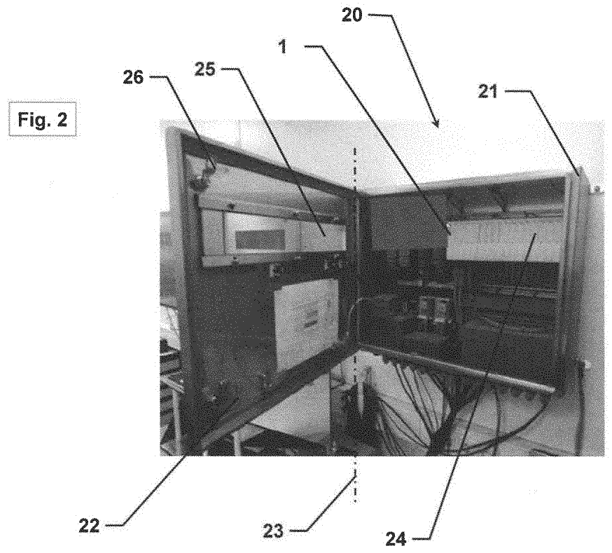

The open switch and control cabinet 20, which has an inspection window 25 extending over the width in the switch cabinet door 22, is represented in FIG. 2. The switch cabinet door 22 is mounted on hinges and pivots about the vertical pivot axis 23. Inside the switch and control cabinet 20, a plurality of electronic components 24 are represented flush with each other and parallel to the gateway module 1, and are fastened to a rearward supporting and supply structure. In the example shown, the electrical components 24 are in particular a gateway and/or I/O module of the I/O system. Various cables for carrying data and power are arranged at the bottom of the switch and control cabinet 20.

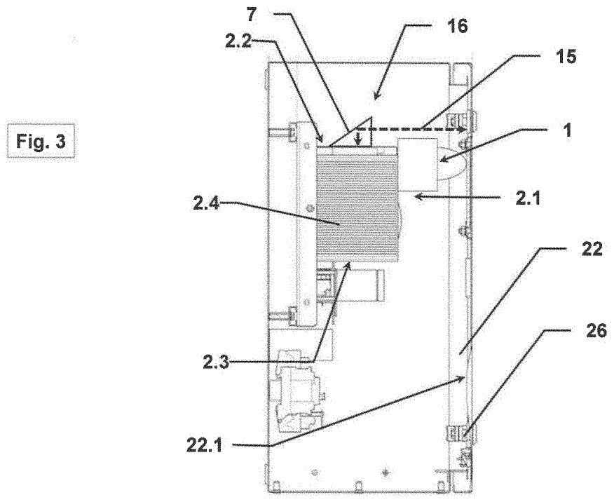

An embodiment of the switch and control cabinet 20 analogous to FIG. 1 is shown in FIG. 3, wherein the gateway module 1 is represented with an alternative arrangement of the ultrasonic sensor in the gateway module 1 with a closed side face 2.4. The difference from the embodiment according to FIG. 1 consists of the fact that the sensor window 6 is arranged on the top 2.2 and, adjacent or covering the sensor window 6, a hood-like directing element 16 comprising a reflective element 7 is provided which directs the sound direction 15 and deflects the ultrasound emerging from the sensor window 6 by 90° and guides it in the direction of the switch cabinet door 22, with the result that, in an ideal case, the ultrasound strikes the inner surface 22.1 of the switch cabinet door 22, or an inspection window 25 arranged there, perpendicularly and is correspondingly reflected. In an analogous manner, the sensor window 6 and an associated directing element 16 as well as the associated reflective element 7 could be arranged at the bottom 2.3 or in the side face 2.4.

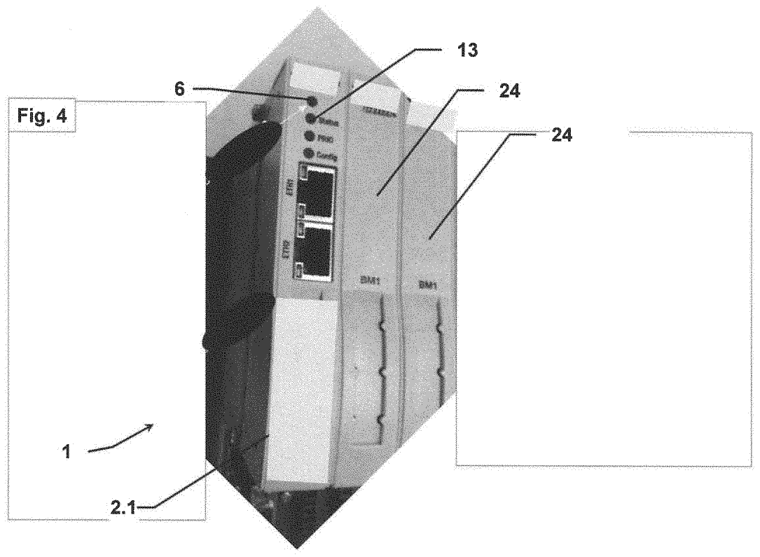

In FIG. 4, the gateway module 1 is arranged parallel and flush with further electronic components 24, which can likewise be formed as I/O system components. The round sensor window 6, behind which the ultrasonic sensor 10 is arranged inside, can be seen on the front 2.1 of the gateway module 1 at the upper end. Below the sensor window 6, an LED display 13 is provided, by means of which an optical warning and/or status notification can be given. Further LED displays and two slots for ethernet connectors can be seen below the sensor window 6 and the LED display 13.

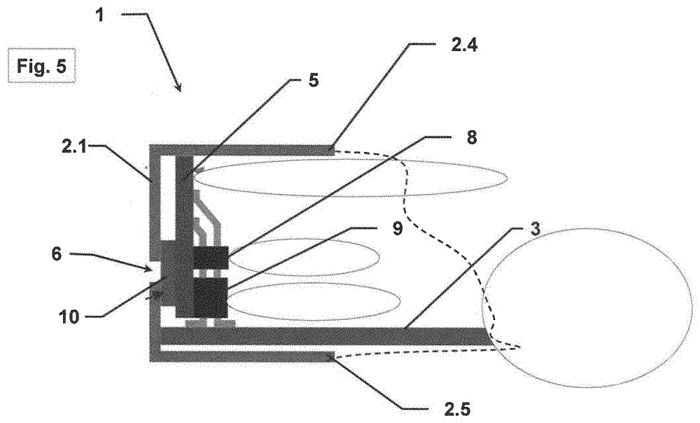

In the schematic illustration according to FIG. 5, a section of the gateway module 1 can be seen, the central printed circuit board 3 (board) of which extends parallel to the only partially represented side walls 2.4, 2.5. Via the pin header 8 and the socket header 9 on its rear side, the sensor printed circuit board 5 is connected to the printed circuit board 3, among other things. The actual ultrasonic sensor 10 is arranged on the front side of the sensor printed circuit board 5 and directly behind the sensor window 6 in the front 2.1 of the gateway module 1.

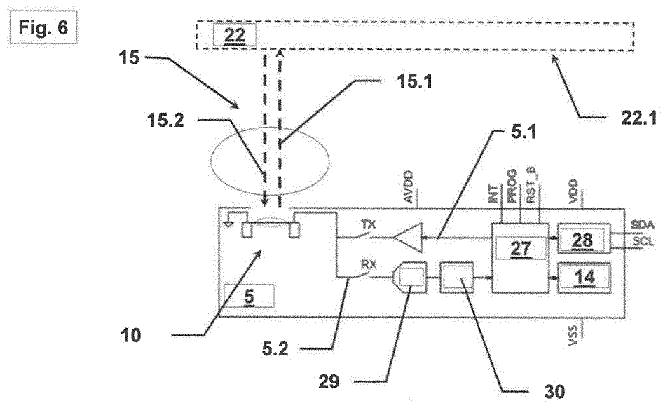

FIG. 6 shows the schematic structure of the ultrasonic sensor 10 with associated sensor printed circuit board 5 as a circuit diagram. A controller 27 and an Inter-Integrated Circuit 28 (I²C) are provided on the sensor printed circuit board 5. Prompted by the controller 27 via the TX path 5.1, the ultrasonic sensor 10 emits sound 15.1 (dashed arrow) intermittently, which strikes the inner surface 22.1 of a facing switch cabinet door 22. From there, the sound is reflected and received by the ultrasonic sensor 10 as reflected sound 15.2 (dashed arrow), and the measured values/data, such as for example the travel time and/or the sound intensity, are fed via the RX path 5.2, an analogue-to-digital converter 29 (ADC) and a digital signal processor 30 (DSP) to the controller 27. The data are then stored in a data store 14 of the sensor printed circuit board 5 at least periodically. The processor (host processor) of the gateway module 1 has access to this data store 14 and can retrieve these data and process them further, if necessary.

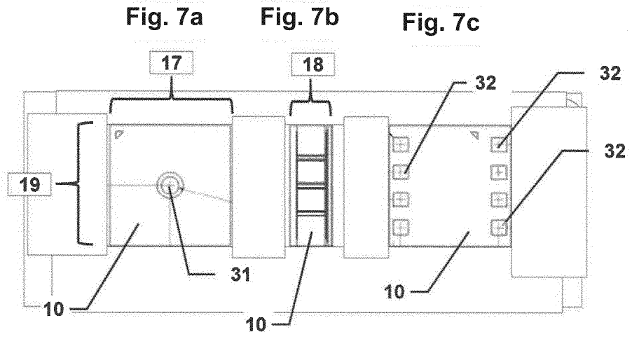

Finally, FIG. 7 shows the actual ultrasonic sensor 10 in three views (a, b and c). In the example shown, the ultrasonic sensor 10 has a width 17 and a length 19 in each case of 3.5 mm (FIG. 7a) and a height 18 of 1.26 mm (FIG. 7b), wherein the sound outlet 31 is arranged in the centre of the ultrasonic sensor 10 (FIG. 7a). In FIG. 7c, eight soldered connection elements 32 are provided for connection to the sensor printed circuit board 5 or its tracks and associated components.

As specified above, the gateway module is only one possible type of structure or component of an I/O system component. Only the elements essential for the invention have been described in the present case, with the result that the other usual and/or necessary components or wires can be added or combined, if necessary. Unless explicitly explained and defined separately, the electrical engineering abbreviations and symbols used have their usual meaning to a person skilled in the art.

### LIST OF REFERENCE NUMBERS

1 gateway module as I/O system component
2 housing
2.1 front
2.2 top
2.3 bottom
2.4 side face
2.5 side face
3 printed circuit board
5 sensor printed circuit board
5.1 TX path
5.2 RX path
6 sensor window
7 reflective element
8 pin header
9 socket header
10 ultrasonic sensor
11 temperature sensor
12 humidity sensor
13 LED display
14 data store
15 sound direction
15.1 sound, emitted
15.2 sound, reflected
16 directing element
17 width
18 height
19 length
20 switch and control cabinet
21 switch and control cabinet housing
22 switch cabinet door
22.1 surface, inner
23 pivot axis
24 electronic component
25 inspection window
26 locking device
27 controller
28 Inter-Integrated Circuit (I²C)
29 analogue-to-digital converter (ADC)
30 digital signal processor (DSP)
31 sound outlet
32 soldered connection element

1. An I/O system component for a switch and control cabinet for components and/or functional units of an I/O network, comprising:
a housing with a front, a top, a bottom, at least one side face, and a sensor window;
at least one ultrasonic sensor for detecting at least one physical quantity, the at least one ultrasonic sensor being arranged behind the sensor window; and
at least one printed circuit board, the at least one ultrasonic sensor being connected to the printed circuit board so as to carry data.

2. The I/O system component according to claim 1, wherein the at least one ultrasonic sensor is arranged on a sensor printed circuit board, and the sensor printed circuit board is connected to the printed circuit board so as to carry data.

3. The I/O system component according to claim 1, further comprising at least one temperature sensor and/or humidity sensor.

4. The I/O system component according to claim 1, wherein the at least one ultrasonic sensor is configured to emit ultrasonic waves such that a beam angle of the ultrasonic waves strike a surface facing the front of the housing perpendicularly, and wherein the at least one ultrasonic sensor is configured to determine a distance and/or changes in distance from an inner surface of a door or a cover to the I/O system component.

5. The I/O system component according to claim 1, wherein the sensor window is arranged in the front of the housing, and wherein no ultrasound-directing reflective element is arranged adjacent to the sensor window.

6. The I/O system component according to claim 1, wherein the sensor window is arranged in the top, the bottom and/or one of the at least one side faces, and wherein an ultrasound-directing reflective element is arranged adjacent to the sensor window, the ultrasound-directing reflective element configured to redirect ultrasonic waves by 90° toward a surface facing the front of the housing.

7. The I/O system component according to claim 1, wherein the I/O system component is a gateway module, I/O module, head station or network element/unit for supplying power.

8. A switch and control cabinet for components and/or functional units of an I/O system network, comprising:
a switch and control cabinet housing with a switch cabinet door tiltably and/or pivotably mounted on at least one pivot axis,
at least one I/O system component, as well as current-carrying and/or fastening means for the at least one I/O system component, wherein
the at least one I/O system component comprises an ultrasonic sensor configured to determine the distance and/or the change in distance of an inner surface of the switch cabinet door from the at least one I/O system component and/or a subcomponent of the I/O system component.

9. The switch and control cabinet according to claim 8, wherein the at least one I/O system component comprises:
a housing with a front, a top, a bottom, at least one side face, and a sensor window; and
at least one printed circuit board, the ultrasonic sensor being connected to the printed circuit board so as to carry data, wherein
the ultrasonic sensor is arranged behind the sensor window.

10. The switch and control cabinet according to claim 9, wherein at least one inspection glass is arranged in the switch cabinet door.

11. The switch and control cabinet according to claim 10, wherein the ultrasonic sensor, the sensor window and/or a reflective element is arranged at a height of and/or opposite the at least one inspection glass.

12. The switch and control cabinet according to claim 8, further comprising at least one further electronic component and associated current-carrying and/or fastening means.

13. A method for monitoring a switch cabinet door of a switch and control cabinet for components and/or functional units of an I/O network, comprising:
determining the actual position of the switch cabinet door compared to a target position of the switch cabinet door using a sensor, the actual position and the target position determined as a distance and/or change in distance of an inner surface of the switch cabinet door from an I/O system component and/or a subcomponent of the I/O system component located inside the switch and control cabinet; and
saving data about the distances and/or changes in distance at least temporarily in a connected storage medium and/or triggering a warning or notification signal.

14. The method according to claim 13, wherein the warning or notification signal is triggered after a defined deviation time from the target position and/or after a total number of deviation times from the target position.

15. The method according to claim 13, wherein the sensor is an ultrasonic sensor.

16. The method according to claim 15, wherein the ultrasonic sensor is arranged inside the I/O system component.

17. The method according to claim 13, wherein the I/O system component comprises:
a housing with a front, a top, a bottom, at least one side face, and a sensor window; and
at least one printed circuit board, the ultrasonic sensor being connected to the printed circuit board so as to carry data, wherein
the ultrasonic sensor is arranged behind the sensor window

18. The method according to claim 13, wherein the switch and control cabinet
a switch and control cabinet housing with a switch cabinet door tiltably and/or pivotably mounted on at least one pivot axis.

19. The method according to claim 13, wherein the ultrasonic sensor is configured to carry out the distance measurements independently at a configurable sampling rate, wherein measured values and/or data derived therefrom is saved in a data store.

20. The method according to claim 19, wherein a microcontroller is provided on a printed circuit board of the I/O system component, and wherein the microcontroller reads the measured values and/or data from the data store at least periodically for further processing.
